(19) United States
(12) Patent Application Publication
(10) Pub. No.: US 2026/0120041 A1
(43) Pub. Date: Apr. 30, 2026

(54) KNOW-HOW COLLECTION DEVICE AND STORAGE MEDIUM

(71) Applicant: TOYOTA JIDOSHA KABUSHIKI KAISHA, Toyota-shi (JP)

(72) Inventors: Masayuki OKAMOTO, Nagoya-shi (JP); Manabu OKUYAMA, Nisshin-shi (JP); Naoki YAMAMURO, Nagoya-shi (JP); Yasuomi TAKEUCHI, Toyota-shi (JP)

(73) Assignee: TOYOTA JIDOSHA KABUSHIKI KAISHA, Toyota-shi (JP)

(21) Appl. No.: 19/324,636

(22) Filed: Sep. 10, 2025

(30) Foreign Application Priority Data
Oct. 31, 2024 (JP) 2024-192490

(51) Int. Cl. G06Q 10/067; G06N 20/00

(52) U.S. Cl. CPC G06Q 10/067; G06N 20/00

(57) ABSTRACT

A know-how collection device includes a control unit that causes a model to generate one or more questions regarding know-how relating to business operations, outputs the one or more questions to a user, receives, from the user, input that is one or more replies to the one or more questions, and then assesses an information quantity contained in the one or more replies, adjusts a way in which questions are asked by the model, in accordance with the information quantity that is assessed, causes the model to generate a next question regarding the know-how, and outputs the next question to the user. The model is, for example, generative artificial intelligence.

### CROSS-REFERENCE TO RELATED APPLICATION

This application claims priority to Japanese Patent Application No. 2024-192490 filed on Oct. 31, 2024. The disclosure of the above-identified application, including the specification, drawings, and claims, is incorporated by reference herein in its entirety.

### BACKGROUND

### 1. Technical Field

The present disclosure relates to a know-how collection device and a storage medium.

### 2. Description of Related Art

Japanese Patent No. 7473270 (JP 7473270 B) discloses creating second level script data based on first level script data, and outputting a lecture including speech uttering text data of the second level script data, and a video of an avatar lecturer.

### SUMMARY

Consideration is not given to an efficient method for collecting know-how in JP 7473270 B.

An object of the present disclosure is to efficiently collect know-how by utilizing models such as generative AI or the like. “AI” is an abbreviation for artificial intelligence.

A know-how collection device according to the present disclosure includes a control unit that causes a model to generate one or more questions regarding know-how relating to business operations, outputs the one or more questions to a user, receives, from the user, input that is one or more replies to the one or more questions, and then assesses an information quantity that is contained in the one or more replies, adjusts a way in which questions are asked by the model, in accordance with the information quantity that is assessed, causes the model to generate a next question regarding the know-how, and outputs the next question to the user.

According to the present disclosure, know-how can be collected efficiently.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a know-how utilization system according to an embodiment of the present disclosure; and

FIG. 2 is a flowchart showing operations of a know-how collection device according to the embodiment of the present disclosure.

### DETAILED DESCRIPTION OF EMBODIMENTS

Hereinafter, an embodiment of the present disclosure will be described with reference to the drawings. In each of the drawings, the same or corresponding portions are denoted by the same reference signs. In the description of the present embodiment, description of the same or corresponding components will be appropriately omitted or simplified.

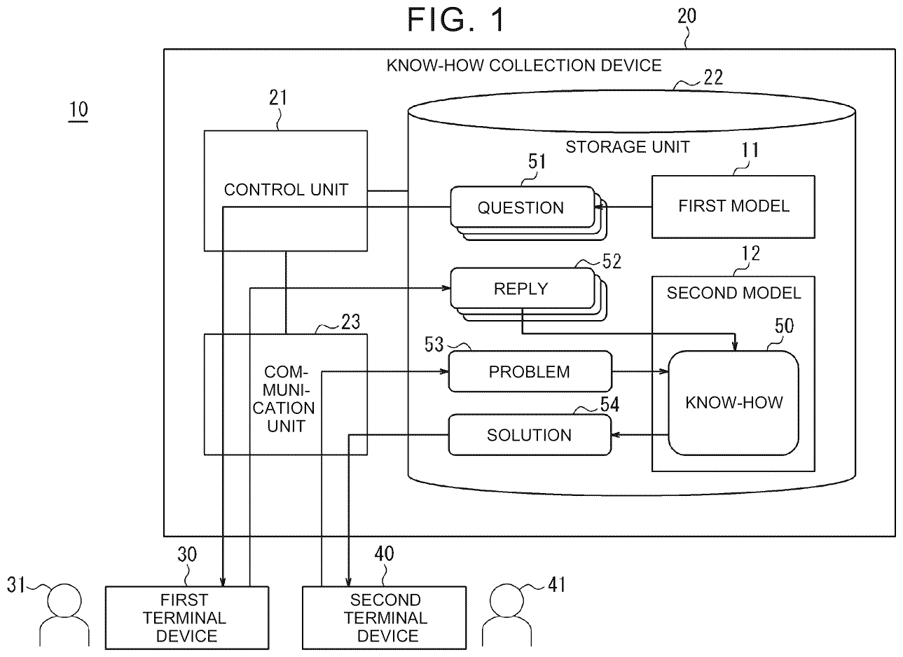

A configuration of a know-how utilization system 10 according to the present embodiment will be described with reference to FIG. 1.

The know-how utilization system 10 includes a know-how collection device 20, a first terminal device 30, and a second terminal device 40. The know-how collection device 20 is capable of communicating with the first terminal device 30 and the second terminal device 40, either directly or via a network. The network includes the Internet, at least one WAN, at least one MAN, or any combination thereof. The term “WAN” is an abbreviation for “wide area network”. The term “MAN” is an abbreviation for “metropolitan area network”.

The know-how collection device 20 is a computer such as a server or the like that is installed in a facility such as a data center, and that belongs to a cloud computing system or some other computing system. The know-how collection device 20 includes a control unit 21, a storage unit 22, and a communication unit 23.

The control unit 21 includes at least one processor, at least one programmable circuit, at least one dedicated circuit, or any combination thereof. The processor is a general-purpose processor such as a CPU, a GPU, or the like, or a dedicated processor that is specialized for specific processing. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 21 executes processing related to operations of the know-how collection device 20, while controlling each part of the know-how collection device 20.

The storage unit 22 includes at least one semiconductor memory, at least one magnetic memory, at least one optical memory, or any combination thereof. The semiconductor memory is, for example, RAM, ROM, or flash memory. The term “RAM” is an abbreviation for “random access memory”. The term “ROM” is an abbreviation for “read-only memory”. The storage unit 22 functions as, for example, a main storage device, an auxiliary storage device, or cache memory. The storage unit 22 stores information that is used in the operations of the know-how collection device 20 and information that is obtained by the operations of the know-how collection device 20.

The communication unit 23 includes at least one communication module. The communication module is, for example, an interface compatible with the LAN communication standard. The term “LAN” is an abbreviation for “local area network”. The communication unit 23 communicates with the first terminal device 30 and the second terminal device 40. The communication unit 23 receives information that is used in the operations of the know-how collection device 20, and also transmits information that is obtained by the operations of the know-how collection device 20.

Functions of the know-how collection device 20 are realized by executing a program according to the present embodiment by the processor serving as the control unit 21. That is to say, the functions of the know-how collection device 20 are realized by software. The program causes a computer to execute the operations of the know-how collection device 20, thereby causing the computer to function as the know-how collection device 20.

The program can be stored in a non-transitory computer-readable medium (storage medium). The non-transitory computer-readable medium is, for example, flash memory, a magnetic recording device, an optical disc, a magneto-optical recording medium, or ROM. The program is distributed, for example, by selling, transferring, or lending a portable medium in which the program is stored. The program may be stored in storage of the server and transferred from the server to other computers to distribute the program. The program may be provided as a program product.

The computer temporarily stores the program that is stored in the portable medium or the program that is transferred from the server in the main storage device, for example. The computer then causes the processor to read the program that is stored in the main storage device, and causes the processor to execute processing in accordance with the program that is read. The computer may read the program directly from the portable medium and execute processing in accordance with the program. The computer may successively execute processing in accordance with the program that is received, each time the program is transferred from the server to the computer. The program includes information that is provided for processing to be performed by electronic computers, and that is information equivalent to a program. For example, data that is not a direct command to a computer but has a nature of defining the processing of the computer corresponds to the “information equivalent to a program”.

Part or all of the functions of the know-how collection device 20 may be realized by a programmable circuit or a dedicated circuit serving as the control unit 21. That is to say, part or all of the functions of the know-how collection device 20 may be realized by hardware.

The first terminal device 30 and the second terminal device 40 are each mobile devices such as a smartphone, a tablet, or the like, or a PC, used by a first user 31 and a second user 41. The term “PC” is an abbreviation for “personal computer”.

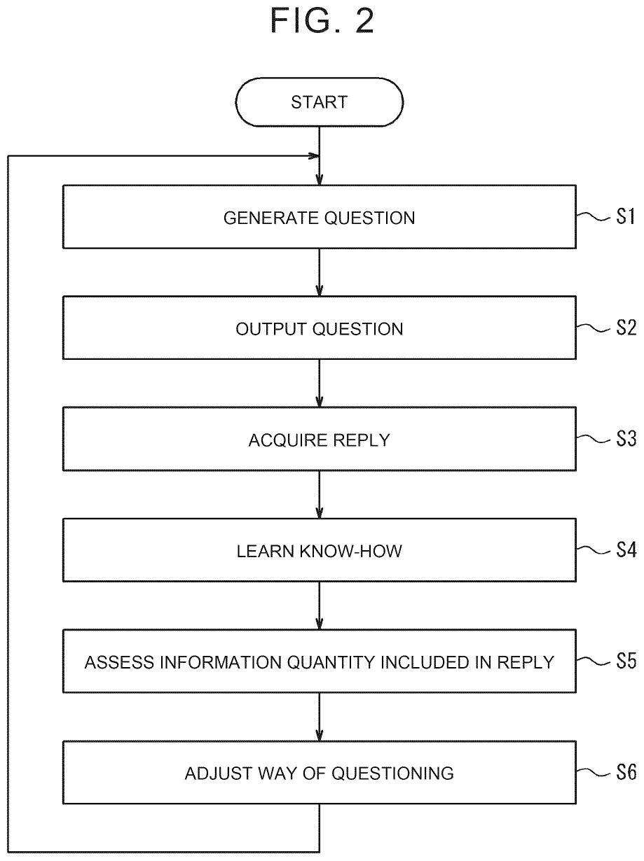

Further, the operations of the know-how collection device 20 according to the present embodiment will be described with reference to FIG. 2. The operations that are described below correspond to a know-how collection method according to the present embodiment. That is to say, the know-how collection method according to the present embodiment includes steps S1 to S6 shown in FIG. 2.

In S1, the control unit 21 causes a first model 11 to generate one or more questions 51 about know-how 50 relating to business operations. The know-how 50 refers to specific or specialized knowledge, technology, techniques, or information. The know-how 50 is typically communicated by verbal, visual, or action-based instructions. The know-how 50 can be applied to work such as screwing or assembling, operating an application or software, or procedures for carrying out business operations and so forth, but is not limited to these. The first model 11 is, for example, generative AI such as an LLM or the like, and based on input of a prompt, which is an instruction from the first user 31 or an administrator of the know-how 50, outputs text corresponding to the prompt. The term “LLM” is an abbreviation for “large language model”. The first model 11 may output information in a form other than text, such as an image, in addition to or instead of text.

In S2, the control unit 21 outputs one or more questions 51, generated in S1, to the first user 31. Specifically, the control unit 21 transmits the one or more questions 51 to the first terminal device 30 via the communication unit 23. Upon receiving the one or more questions 51 from the know-how collection device 20, the first terminal device 30 outputs, to the first user 31, the one or more questions 51 received, by displaying the one or more questions 51 on a screen or performing output as audio. Upon receiving input of one or more replies 52 to the one or more questions 51, the first terminal device 30 transmits the one or more replies 52 to the know-how collection device 20.

In S3, the control unit 21 acquires the one or more replies 52 for the one or more questions 51 output in S2. Specifically, the control unit 21 receives the one or more replies 52 from the first terminal device 30 via the communication unit 23.

In S4, the control unit 21 provides the one or more replies 52 acquired in S3 as input to a second model 12, and causes the second model 12 to learn the know-how 50. The know-how 50 is stored and learned as text, electronic documents, audio, images, or any combination thereof. The know-how 50 includes knowledge that is acquired by veterans or experts in a particular field, practical technology or techniques that are cultivated through experience in that field, or all of these. The second model 12 is, for example, generative AI such as an LLM or the like, and based on input of a prompt, which is an instruction from the second user 32, outputs text corresponding to the prompt. The second model 12 may output information in a form other than text, such as an image or the like, in addition to or instead of text.

When one or more replies 52 are acquired in S3, i.e., when input, which is one or more replies 52 to one or more questions 51 from the first user 31, is received, the control unit 21 assesses the information quantity that is contained in the one or more replies 52 in S5. Specifically, the control unit 21 assesses the information quantity by subtracting duplication with accumulated knowledge, from knowledge that is conveyed in the one or more replies 52. Alternatively, when a plurality of the questions 51 is output as the one or more questions 51 in S2, the control unit 21 may assess the information quantity by subtracting duplication among the replies 52 from the knowledge that is conveyed in a plurality of the replies 52 to the questions 51, obtained as the one or more replies 52 in S3. That is to say, the control unit 21 assesses the information quantity by performing subtraction from accumulated knowledge, by removing duplication from the conversation, or by both. It is also conceivable that repetition within the same conversation can be used as an indicator to determine that nothing is being said that is incorrect.

In S6, the control unit 21 adjusts the way in which the first model 11 asks questions depending on the information quantity assessed in S6. The way in which questions are asked is adjusted, for example, by the administrator of the know-how 50 instructing the first model 11 regarding the way in which questions are asked, via a prompt. One conceivable example would be to adapt the listening style to the way that the other party is speaking. When the first user 31, who is a veteran, is asked about the use of a part X in a process A, and the veteran speaks in depth about the use of the part X in the process A, i.e., when the information quantity is great, the control unit 21 detects this and continues to ask in depth about the use of the part X in the process A. On the other hand, when the veteran mentions using the part X in a process B, the control unit 21 detects this and asks about using the part X in other processes as well. As another conceivable example, listening patterns can be prepared in advance. When a great information quantity is obtained when the veteran is asked in depth regarding the use of the part X in the process A, the control unit 21 continues to ask in-depth questions regarding the use of the part X in the process A. When not much information quantity is obtained, the control unit 21 also inquires about the use of the part X in other processes.

After S6, at least steps S1 to S4 are executed for the next question. That is to say, in S1, the control unit 21 causes the first model 11 to generate the next question regarding the know-how 50. In S2, the control unit 21 outputs the next question to the first user 31. In S3, the control unit 21 acquires the reply to the next question. In S4, the control unit 21 provides the second model 12 with an input of the reply to the next question, and causes the second model 12 to further learn the know-how 50. When collection of the know-how 50 is to be continued, steps S5 and S6 are further executed. That is to say, in S5, the control unit 21 assesses the information quantity that is contained in the reply to the next question. In S6, the control unit 21 further adjusts the way in which the first model 11 asks questions depending on the information quantity that is assessed in S6.

Separately from steps S1 to S6, upon receiving input of a problem 53 related to business operations from the second user 41, the control unit 21 provides the input of the problem 53 to the second model 12. The control unit 21 acquires information regarding a solution 54 that utilizes the know-how 50 for the problem 53 from the second model 12. The control unit 21 outputs the acquired information regarding the solution 54 to the second user 41.

Specifically, when the second user 41 inputs the problem 53 into the second terminal device 40, the second terminal device 40 transmits the problem 53 to the know-how collection device 20. The control unit 21 receives the problem 53 from the second terminal device 40 via the communication unit 23. Upon receiving the problem 53, i.e., upon receiving input of the problem 53 from the second user 41, the control unit 21 provides the input of the problem 53 to the second model 12, and acquires information regarding the solution 54 to the problem 53, that utilizes the know-how 50, from the second model 12. The control unit 21 transmits the information regarding the solution 54 that is acquired to the second terminal device 40 via the communication unit 23. Upon receiving the information regarding the solution 54 from the know-how collection device 20, the second terminal device 40 outputs the information regarding the solution 54 to the second user 41, by displaying on a screen or outputting as audio, the received information regarding the solution 54.

Ways of questioning that allow the other party to speak more at case vary from one person to another. In the present embodiment, content of the questioning for collecting the know-how 50 can be changed in accordance with the information quantity that is obtained when collecting the know-how 50, and accordingly the know-how 50 can be collected efficiently. The content of the questioning may be changed in accordance with not only the information quantity, but also facial expressions, amount of speech, and so forth, of the other party. The content of the questioning may include polite interjections.

The present disclosure is not limited to the embodiment that is described above. Changes may be made without departing from the spirit and scope of the present disclosure.

What is claimed is:

1. A know-how collection device comprising a control unit that causes a model to generate one or more questions regarding know-how relating to business operations,
outputs the one or more questions to a user,
receives, from the user, input that is one or more replies to the one or more questions, and then assesses an information quantity that is contained in the one or more replies,
adjusts a way in which questions are asked by the model, in accordance with the information quantity that is assessed,
causes the model to generate a next question regarding the know-how, and
outputs the next question to the user.

2. The know-how collection device according to claim 1, wherein the control unit assesses the information quantity by subtracting duplication with accumulated knowledge, from knowledge that is conveyed in the one or more replies.

3. The know-how collection device according to claim 1, wherein the control unit outputs a plurality of questions as the one or more questions, and
assesses the information quantity by subtracting duplication among replies from knowledge conveyed in a plurality of replies to the questions, obtained as the one or more replies.

4. The know-how collection device according to claim 1, wherein the control unit,
with the model as a first model, provides a second model with the input of the one or more replies, and causes the second model to learn the know-how,
with the user as a first user, receives input of a problem related to business operations from a second user, upon which the control unit provides the input of the problem to the second model,
acquires information regarding a solution to the problem, utilizing the know-how from the second model, and
outputs the information regarding the solution that is acquired, to the second user.

5. A non-transitory storage medium storing a program for causing a computer to function as the know-how collection device according to claim 1.
